(19) United States
(12) Patent Application Publication
(10) Pub. No.: US 2020/0182195 A1
(43) Pub. Date: Jun. 11, 2020

(54) JET ENGINE WITH CONTINUOUS AND DISCONTINUOUS IMPULSE

(71) Applicant: Antonio Accion Penas, A Coruna (ES)

(72) Inventor: Antonio Accion Penas, A Coruna (ES)

(21) Appl. No.: 16/623,094

(22) PCT Filed: Jun. 11, 2018
(86) PCT No.: PCT/ES2018/070419

§ 371 Date: Dec. 16, 2019

(30) Foreign Application Priority Data
Jun. 15, 2017 (ES) P201730800

(51) Int. Cl. F02K 7/06; F02K 7/20; F02C 5/12

(52) U.S. Cl. CPC F02K 7/06; F02C 5/12; F02K 7/20

(57) ABSTRACT

A jet engine (1) with continuous and discontinuous impulse, which comprises a diffuser (2) with a cylindrical exterior shape, a combustion chamber (3), and several fuel injection means (19) and a nozzle (4), both with same exterior shape as the diffuser, a rotating disk chamber (5) that allows air to pass continuously or discontinuously from the diffuser (2) to the combustion chamber (3), an alternative engine with an alternative shaft (13) connected to a main shaft (9) of the engine (1) by means of a first cam (14), several means of stopping the main shaft (9), and a pressurized air chamber (16) connected to the main shaft (9), wherein the fuel injection means (19) are suitable for activating the injection in synchronization with the passage of air from the diffuser (2) to the combustion chamber (3).

### TECHNICAL FIELD OF THE INVENTION

The present invention corresponds to the technical field of the internal combustion engine thermal machines used in the aviation sector, such as gas turbines, ramjet engines, turbojets, pulsejet engines, and other jet engines.

### BACKGROUND OF THE INVENTION

There are currently different types of jet engines to propel aircraft. Both pulsejet engines as well as ramjet engines are very inexpensive and easy to build, but both have drawbacks, because on one hand, pulsejet engines break valves very easily after operating for a time, and ramjet engines can only operate when aircraft exceed a minimum speed.

The existence of a jet engine, or any other invention with a similar application in the state of the art, which proposes the use of a ramjet engine that is capable of operating when the aircraft is moving at low speeds, or even while stopped, propelling the aircraft and surpassing said minimum speed without making use of heavy or large mechanism, turbojet engines, or launch vehicles, is not known, at least on the part of the applicant.

### DESCRIPTION OF THE INVENTION

The jet engine with continuous and discontinuous impulse that is described here comprises an air intake diffuser with a cylindrical exterior shape, a combustion chamber with a spark plug and several fuel injection means and an outlet nozzle, both with the same exterior shape as the diffuser.

It also comprises a rotating disk chamber located between the diffuser and the combustion chamber, which allows air to pass continuously or discontinuously from the diffuser to said combustion chamber.

Likewise, the engine comprises an alternative engine with an alternative shaft of that alternative engine connected to the main shaft by means of a first cam, a first sliding crank, and a first tie rod, several means for stopping the main shaft, and a pressurized air chamber with a compressor, connected to the main shaft by means of a second sliding crank and a second tie rod.

The fuel injection means are connected to the main shaft by means of several means of intermittent actuation of the injection means, suitable for activating the injection in synchronization with the passage of the air from the diffuser to the combustion chamber.

According to a preferred embodiment, the discontinuous disk chamber has a first flat cover and a second flat cover secured parallel to the cross-section of the diffuser and the combustion chamber, and with dimensions such that they are larger than them, and a first and a second geared wheel, both arranged in between said covers.

The first wheel is connected coaxially to the main shaft of the engine, and the second wheel and both covers are positioned coaxially with the diffuser, with a same secondary shaft parallel to the main shaft.

In a preferred embodiment, the second wheel has a gear ratio of 3:1 with the first wheel, and the surfaces of both the second wheel and both covers of the rotating disk chamber have three openings and three closed zones, in an alternating and equidistant radial arrangement such that it allows the passage of air from the diffuser to the combustion chamber when the openings of the second wheel coincide with those of the covers and blocks the passage of air when they do not.

According to a preferred embodiment, the actuation means consist of a second cam and a transmission belt.

In another preferred embodiment, the actuation means consist of a solenoid valve.

According to a preferred embodiment, the means of stopping the main shaft consist of a hydraulic brake connected to a brake disk that acts on said main shaft.

According to a preferred embodiment, the compressor of the pressurized air chamber consists of an internal piston, connected perpendicularly at its center to the second sliding crank.

In a preferred embodiment, the engine comprises several electronic means to control the activation and deactivation of the alternative engine, the actuation of the piston of the pressurized air chamber, of the stopping means, and of the spark plug spark.

The engine proposed here provides significant improvements over the state of the art.

This is because it provides a simple, lightweight, and effective mechanism to solve the existing problem in jet engines to propel aircraft, which can be used for aircraft capable of subsonic, supersonic, and hypersonic flight, for a wide range of speeds, from stationary to Mach5 or faster.

Therefore, aircraft that are equipped with this engine can fly at hypersonic speeds without the need for complex or heavy mechanisms, or auxiliary vehicles to achieve a minimum speed, and aircraft that fly at subsonic speeds can have a simpler, lighter engine with a better thrust-weight ratio that if they were equipped with turbojets.

### BRIEF DESCRIPTION OF THE DRAWINGS

In order to provide a better understanding of the characteristics of the invention, in accordance with a preferred practical embodiment of the invention, a set of drawings is included as an integral part of the description, in which the following elements have been represented for the purposes of illustration but not limitation:

FIG. 1.—Shows a perspective view of the jet engine with continuous and discontinuous impulse, for a preferred embodiment of the invention.

FIG. 2.—Shows an exploded view of the rotating disk chamber, for a preferred embodiment of the invention.

### DETAILED DESCRIPTION OF A PREFERRED EMBODIMENT OF THE INVENTION

The figures provided show how in a preferred embodiment of the invention, the jet engine (1) with continuous and discontinuous impulse that is described here comprises an air intake diffuser (2) with a cylindrical exterior shape, a combustion chamber (3) with a spark plug and several fuel injection means (19) and an outlet nozzle (4), both with the same exterior shape as the diffuser (2).

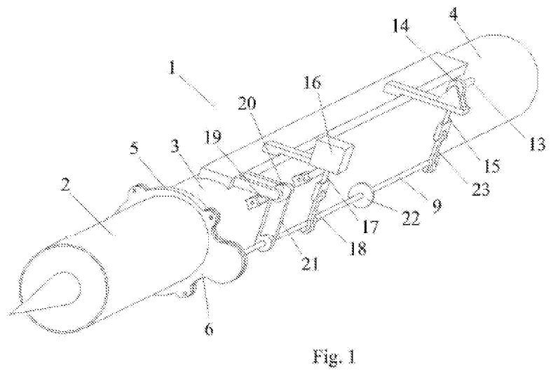

As shown in FIG. 1, the engine (1) also comprises a rotating disk chamber (5) located between the diffuser (2) and the combustion chamber (3). This rotating disk chamber (5) allows air to pass continuously or discontinuously from the diffuser (2) to said combustion chamber (3).

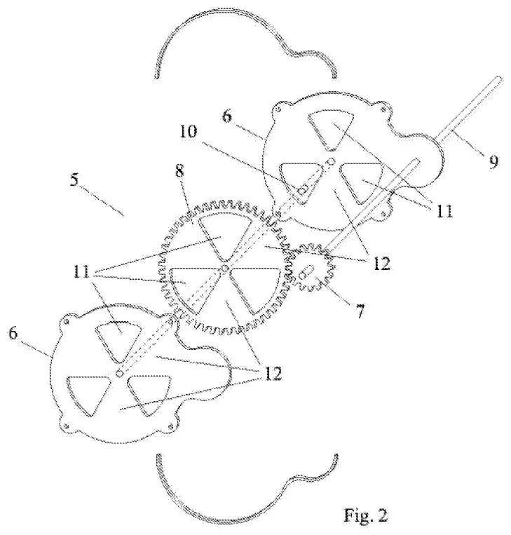

In this preferred embodiment of the invention, as shown in FIG. 2, the rotating disk chamber (5) has a first flat cover (6) and a second flat cover (6) secured parallel to the cross-section of the diffuser (2) and the combustion chamber (3), and with dimensions such that they are larger than them, and a first and a second geared wheel (7,8), both arranged in between said covers (6).

As shown in FIG. 2, the first wheel (7) is connected coaxially to the main shaft (9) of the engine, and the second wheel (8) and both covers (6) are positioned coaxially with the diffuser (2), with a same secondary shaft (10) parallel to the main shaft (9).

In this preferred embodiment of the invention, the second wheel (8) has a gear ratio of 3:1 with the first wheel (7), and the surfaces of both the second wheel (8) and both covers (6) have three openings (11) and three closed zones (12), in an alternating and equidistant radial arrangement such that it allows the passage of air from the diffuser (2) to the combustion chamber (3) when the openings (11) of the second wheel (8) coincide with those of the covers (6) and blocks the passage of air when they do not.

This jet engine (1) with continuous and discontinuous impulse also comprises an alternative engine (not shown) with an alternative shaft (13) of that alternative engine connected to the main shaft (9) by means of a first cam (14), a first sliding crank (15), and a first tie rod (23), several means for stopping the main shaft, and a pressurized air chamber (16) with a compressor, connected to the main shaft (9) by means of a second sliding crank (17) and a second tie rod (18).

Also, in this engine (1), the fuel injection means (19) are connected to the main shaft (9) by means of several means of intermittent actuation of the injection means, suitable for activating the injection in synchronization with the passage of the air from the diffuser (2) to the combustion chamber (3). In this preferred embodiment of the invention, said actuation means consist of a second cam (20) and a transmission belt (21).

What this achieves is that when the aircraft is moving at a slow speed, below the minimum functional speed of a ramjet engine, which is on the order of 320 km/h, or when it is stopped, the alternative engine turns the alternative shaft (13), which turns the main shaft (9) of the engine (1) through the connection provided by the first cam (14), the first sliding crank (15), and the first tie rod (23). Due to the connection by means of the first cam (14) and its eccentricity, the alternative engine turns the alternative shaft (13) with a constant angular velocity, while the main shaft (9) turns at a non-uniform angular velocity.

When the main shaft (9) rotates, it causes the first wheel (7) of the rotating disk chamber (5) to turn, and this first wheel (7) causes the second wheel (8) to turn.

Therefore, when said main shaft (9) is turned, the turning of the second cam (20) to actuate the fuel injection means (19) is generated. This second cam (20) is turned by the connection to the main shaft (9) by means of the transmission belt (21), such that both said second cam (20) and the first wheel (7) turn together with the main shaft (9).

Due to the 3:1 gear ratio between both first and second wheels (7, 8), each revolution of the main shaft (9) generates one rotation of the first wheel (7) and one-third of a revolution of the second wheel (8). Likewise, when the second wheel (8) makes one complete rotation, it generates three revolutions of the first wheel (7) and three revolutions of the second cam (20) of the actuation means, along with its corresponding three injections of fuel.

Thus, thanks to the geometry of the rotating disk chamber (5) and the second cam (20) for the actuation of the fuel injection means (19), when the second wheel (8) is turned, the three closed zones (12) of the second wheel (8) coincide with the openings (11) of both covers (6). At this moment, the fuel injection means (19) are actuated by the eccentricity of the second cam (20) and the fuel-air mixtures is ignited by a spark produced by the spark plug.

This generates the combustion of the fuel-air mixture and increases the temperature to 2300° C. and the air pressure to 50 bar, approximately, with the air discharged through the nozzle (4) at high speed and propelling the aircraft with a discontinuous impulse.

When the rotation of the main shaft (9) is varied, a position in which the openings (11) of the second wheel (8) coincide with those of both covers (6) of the rotating disk chamber (5) is reached. The second cam (20) has also turned, and in this case no longer actuates the fuel injection means (19). Therefore, in this position in which the openings (11) coincide, fuel is not injected and the air from the diffuser (2) circulates through the rotating disk chamber (5) towards the combustion chamber (3) and the nozzle (4) due to the vacuum generated when the air is discharged at high speed by the combustion chamber (3) in the opposite direction from the rotating disk chamber (5).

As soon as the aircraft exceeds the minimum speed, which in this preferred embodiment of the invention is considered to be 320 km/h, the alternative engine turns off and the means for stopping the main shaft are activated. In this preferred embodiment of the invention, said stopping means consist of a hydraulic brake connected to a brake disk (22) that acts on the main shaft (9) and cause it to stop turning and stop at an indeterminate angle.

Following this, said hydraulic brake is deactivated and pressurized air is injected into the pressurized air chamber (16).

In this preferred embodiment of the invention, the compressor of the pressurized air chamber (16) consists of an internal piston, connected perpendicularly at its center to the second sliding crank (17). When pressurized air is injected, the piston lowers, actuating the second sliding crank (17) and the second tie rod (18), such that the main shaft (9) is fixed at an angle at which the openings (11) of the second wheel (8) and the two covers (6) line up. At this moment, the fuel injection means (19) are actuated, and the fuel-air mixtures is ignited by a spark produced by the spark plug.

Therefore, at this time, fuel can be injected constantly and the engine (1) will operate continuously. In this case, the hot air is not discharged through the diffuser (2) because the aircraft has exceeded the minimum speed considered of 320 km/h.

On the other hand, when the aircraft is travelling faster than said minimum speed of 320 km/h without exceeding the maximum speed for functioning in discontinuous mode of 640 km/h, the engine (1) operating in ramjet mode may return to operation in discontinuous mode.

To do this, the pressure in the pressurized air chamber (16) is reduced, actuation of the fuel injection means (19) is stopped, and the alternative engine is turned on so that the engine operates in discontinuous mode.

In this preferred embodiment of the invention, the engine (1) comprises several electronic means to control the activation and deactivation of the alternative engine, the actuation of the piston of the pressurized air chamber (16), of the stopping means, and of the spark plug spark.

The embodiment described constitutes just one example of the present invention; therefore, the specific details, terms, and phrases used in this description must not be considered as limiting, but rather merely as the representative base that provides an understandable description, as well as sufficient information for a person skilled in the art to apply the present invention.

The jet engine with continuous and discontinuous impulse described here provides significant improvements over the state of the art.

It provides a simple and effective engine that allows aircraft that are equipped with it to fly at hypersonic speeds without the need for complex or heavy mechanisms, or auxiliary vehicles to achieve a minimum speed. In addition, aircraft that fly at subsonic speeds have an engine that is simpler, more lightweight, and with a better thrust-weight ratio than a turbojet.

Therefore, this makes dual functioning of the engine possible, operating as a ramjet engine when the aircraft exceeds the minimum speed for pulsejet engines, up to hypersonic speeds, and as a discontinuous impulse jet engine while the minimum speed is not exceeded.

1. A jet engine (1) with continuous and discontinuous impulse, characterized in that it comprises:
an air intake diffuser (2) with a cylindrical exterior shape;
a combustion chamber (3) with a spark plug and several fuel injection means (19) and an outlet nozzle (4), both with the same exterior shape as the diffuser;
reciprocating engine with an alternative shaft (13) of said reciprocating engine connected connected to a main shaft (9) of the engine (1) by means of a first cam (14), a first sliding crank (15) and a first tie rod (23)
several means of stopping the main shaft (9), and;
a pressurized air chamber (16) with a compressor, connected to the main shaft (9) by means of a second sliding crank (17) and a second tie rod (18) and;
a rotating disk chamber (5) located between the diffuser (2) and the combustion chamber (3), which allows air to pass continuously or discontinuously from the diffuser (2) to said combustion chamber (3); said rotating disk chamber (5) has a first flat cover (6) and a second flat cover (6) secured parallel to the cross-section of the diffuser (2) and the combustion chamber (3), and with dimensions such that they are larger than said cross-sections, and a first and a second geared wheel (7, 8), both arranged in between said covers (6), wherein the first wheel (7) is connected coaxially to the main shaft (9) of the engine (1), and the second wheel (8) and both covers (6) are positioned coaxially with the diffuser (2), with a same secondary shaft (10) parallel to the main shaft (9).
wherein the fuel injection means (19) are connected to the main shaft(49) by means of several means of intermittent actuation of the injection means, suitable for activating the injection in synchronization with the passage of the air from the diffuser (2) to the combustion chamber (3).

2. The jet engine (1) with continuous and discontinuous impulse, according to claim 1, characterized in that the second wheel (8) has a gear ratio of 3:1 with the first wheel (7), and the surfaces of both the second wheel (8) and both covers (6) of the rotating disk chamber (5) have three openings (11) and three closed zones (12), in an alternating and equidistant radial arrangement such that it allows the passage of air from the diffuser (2) to the combustion chamber (3) when the openings (11) of the second wheel (8) coincide with those of the covers (6) and blocks the passage of air when they do not.

3. The jet engine (1) with continuous and discontinuous impulse, according to claim 1, characterized in that the means of intermittent actuation consist of a second cam (2) and a transmission belt (21).

4. The jet engine (1) with continuous and discontinuous impulse according to claim 1, characterized in that the means of intermittent actuation consist of a solenoid valve.

5. The jet engine (1) with continuous and discontinuous impulse, according to claim 1, characterized in that the means of stopping the main shaft (9) consist of a hydraulic brake connected to a brake disk (22) that acts on said main shaft (9).

6. The jet engine (1) with continuous and discontinuous impulse, according to claim 1, characterized in that the compressor of the pressurized air chamber (16) consists of an internal piston, connected perpendicularly at its center to the second sliding crank (17).

7. The jet engine (1) with continuous and discontinuous impulse, according to claim 1, characterized in that it comprises several electronic means to control the activation and deactivation of the reciprocating engine, the actuation of the piston of the pressurized air chamber (16), of the stopping means, and of the spark plug spark.

8. A jet engine (1) with continuous and discontinuous impulse, comprising:
an air intake diffuser (2) with a cylindrical exterior shape;
a combustion chamber (3) with a spark plug and a plurality of fuel injectors (19) and an outlet nozzle (4), both with the same exterior shape as the diffuser;
a reciprocating engine with an alternative shaft (13) of said reciprocating engine connected connected to a main shaft (9) of the engine (1) by a first cam (14), a first sliding crank (15) and a first tie rod (23);
a plurality of brakes for stopping the main shaft (9);
a pressurized air chamber (16) with a compressor, connected to the main shaft (9) by a second sliding crank (17) and a second tie rod (18);
a rotating disk chamber (5) located between the diffuser (2) and the combustion chamber (3), which allows air to pass continuously or discontinuously from the diffuser (2) to said combustion chamber (3); said rotating disk chamber (5) has a first flat cover (6) and a second flat cover (6) secured parallel to the cross-section of the diffuser (2) and the combustion chamber (3), and with dimensions such that they are larger than said cross-sections, and a first and a second geared wheel (7, 8), both arranged in between said covers (6), wherein the first wheel (7) is connected coaxially to the main shaft (9) of the engine (1), and the second wheel (8) and both covers (6) are positioned coaxially with the diffuser (2), with a same secondary shaft (10) parallel to the main shaft (9).
wherein the fuel injectors (19) are connected to the main shaft (9) so as to activate the injection of fuel in synchronization with the passage of the air from the diffuser (2) to the combustion chamber (3).
